(19) United States
(12) Patent Application Publication
(10) Pub. No.: US 2025/0368401 A1
(43) Pub. Date: Dec. 4, 2025

(54) FLAME MITIGATING FLUID DISPENSING CLOSURE

(71) Applicant: Mold-Rite Plastics, LLC, Twinsburg, OH (US)

(72) Inventor: Leonora BROZELL, Maumee, OH (US)

(73) Assignee: Mold-Rite Plastics, LLC, Twinsburg, OH (US)

(21) Appl. No.: 19/223,871

(22) Filed: May 30, 2025

Related U.S. Application Data
(60) Provisional application No. 63/655,388, filed on Jun. 3, 2024.

(51) Int. Cl. B65D 47/08; A62C 2/06; A62C 3/06

(52) U.S. Cl. CPC B65D 47/0842; A62C 2/06; A62C 3/065

(57) ABSTRACT

A flame mitigating fluid dispenser for controlling flow of flammable fluid from a container while mitigating flame infiltration. The dispenser configured to attach to the container. The dispenser includes a top wall with an upper surface, a lower surface and defining a thickness between the upper and lower surfaces. The top wall has a dispensing zone where the thickness of the top wall is at least approximately 0.090 inches. A plurality of holes are formed in the top wall in the dispensing zone. The holes extend through the thickness. Each hole has a diameter of approximately 0.030 inches or less at the point where the hole meets the lower surface. Each hole is spaced apart from an adjacent hole by at least approximately 0.030 inches on the upper surface. A sidewall is formed on and depending downward from an outer periphery of the top wall.

### RELATED APPLICATION

This application is related to and claims priority from U.S. Provisional Patent Application No. 63/655,388, filed Jun. 3, 2024, the disclosure of which is incorporated herein by reference in its entirety.

### FIELD OF THE INVENTION

The present invention related to fluid dispensing closures and, more particularly, to a dispenser device that mitigates flame penetration into a container.

### BACKGROUND

Many conventional containers for liquid fuel, such as charcoal lighter fluid, include a closure that includes one to three orifices that are closed with a flip-top cover. One such conventional top is sold by Mold-Rite Plastics, Inc. product no. 10-6156. The product includes three orifices that extend through a top wall of the dispenser. See, FIG. 6. Each orifice has a diameter D1 of 0.058 inches. The orifices are located inside an annular cylindrical spout that is integral with and protrudes outwardly from the top wall. A cover or lid is configured to securely attach to the upper end of the spout and includes a plug seal that extends into the opening at the top of the spout.

The total fluid dispensing area (i.e. the total outflow area of all three orifices combined) is approximately 0.00792 in². The thickness T1 (FIG. 7B) of the top wall where the orifices are located is approximately 0.045 inches. Thus, the total volume of the holes extending through the top wall is approximately 0.00036 in³.

Recently the U.S. Consumer Product Safety Commission (CPSC), in response to the Portable Fuel Container Safety Act of 2020, issued a requirement that portable fuel containers include dispensers designed to inhibit the propagation of an external flame into the container in accordance with ASTM F3429/F3429M-20. A common type of flame mitigation device used with portable fuel containers is a flame arrestor (also known as a flash arresting screen). A flame arrestor is a screen that quenches and cools a flame so that it cannot pass through the flame arrestor. Such a device is generally not feasible in a closure type fluid dispenser.

A need exists for an improved closure design that mitigates flame passage into the container.

### SUMMARY OF THE INVENTION

A flame mitigating fluid dispenser is disclosed for controlling flow of flammable fluid from a container while mitigating flame infiltration. The dispenser configured to attach to the container. The dispenser includes a top wall with an upper surface, a lower surface and defining a thickness between the upper and lower surfaces. The top wall has a dispensing zone where the thickness of the top wall is at least approximately 0.090 inches. A plurality of holes are formed in the top wall in the dispensing zone. The holes extend through the thickness. Each hole has a diameter of approximately 0.030 inches or less at the point where the hole meets the lower surface. Each hole is spaced apart from an adjacent hole by at least approximately 0.030 inches on the upper surface. A sidewall is formed on and depending downward from an outer periphery of the top wall.

The thickness of the top wall in the dispensing zone is preferably thicker than the thickness of the top wall outside of the dispensing zone.

In an embodiment, the dispenser is preferably part of a closure that attaches to the container. The side wall defines an open bottom. The closure includes a spout located on the top wall and includes a spout wall formed integral with and projecting upwards from the top wall. The spout wall surrounds the dispensing zone of the top wall. A lid is attached to the closure by means of an elongated flexible arm and wherein the lid is configured to removably attach to the spout for covering the dispensing zone.

The lid preferably includes a top surface and a locking wall that projects downward from the bottom of the top surface. The locking wall includes a bulbous portion on a lower inner portion of the locking wall configured to engage with a corresponding bulbous portion on the spout wall for securing the lid to the spout when the dispenser is in a locked position.

Preferably at least one safety wall is formed on and extends upwards from the top wall of the closure. The at least one safety wall is spaced apart from the spout. The safety wall is configured to engage with the lid so as to restrict the motion of the lid.

In an embodiment, the dispensing zone is located within the spout and there are preferably at least thirteen holes arranged in a pattern in the dispensing zone of the top wall and spaced substantially equidistant from one another.

The diameter of each hole on the upper surface of the top wall preferably has a diameter of approximately 0.036 inches and the holes account for a total area in the dispensing zone on the upper surface of approximately 0.01344 in².

In another embodiment the dispenser is a fitment configured to fit within a neck of the container. The sidewall of the fitment has at least one ring extending radially outward from the sidewall and a radially outer end having a diameter that is larger than an inner diameter of the neck of the container. The ring has a thickness and material properties so as to be deformable to the contour of the inner diameter of the neck for providing a seal. An upper rim extends radially outward from the top wall and has an outer periphery with a diameter that is slightly larger than the inner diameter of the neck.

In another embodiment, the dispenser is a fitment configured to fit within a neck of the container that includes an outward projecting rim. The sidewall of the fitment has an outer attachment formed around its periphery. The dispenser further includes a cap with an internal attachment configured to mate with the outer attachment on the sidewall for removably securing the cap to the sidewall and covering the top wall. The bottom of the sidewall includes an inner plug seal that has an outer diameter that is sized to engage with and seal against the inner diameter of the neck of the container. A fitment flange extends radially outward from the bottom of the sidewall and includes a downward extending outer ring that is spaced apart from the inner plug seal so as to define an annual gap. The width of the gap is preferably sized to receive the rim of the neck of the container.

In an embodiment, there are about 144 holes with adjacent holes preferably having a spacing of approximately 0.066 inches center to center.

The holes may be arranged in a pattern such that six of the holes are arranged in a circle with their centers located on a diameter of approximately 0.132 inches with an additional hole centered inside the six holes.

### BRIEF DESCRIPTION OF THE DRAWINGS

For the purpose of illustrating the invention, there are shown in the drawings embodiments that are presently preferred; it being understood, however, that this invention is not limited to the precise arrangements and constructions particularly shown.

FIG. 1 is a top perspective view of a flame mitigating fluid dispenser according to an embodiment of the invention where the dispenser is in the form of a child resistant closure shown in its open position.

FIG. 2 is a top view of the flame mitigating fluid dispensing closure of FIG. 1.

FIG. 3 is a bottom view of the flame mitigating fluid dispensing closure of FIG. 1.

FIG. 4 is a perspective view of a cross section of the flame mitigating fluid dispensing closure of FIG. 1.

FIG. 5 is a cross-sectional view of the flame mitigating fluid dispensing closure of FIG. 1.

FIG. 6 is a top view of a portion of a prior art fluid dispensing closure.

FIG. 6A is an enlarged cross-sectional view of the prior art fluid dispensing closure shown in FIG. 6.

FIG. 7A is an enlarged view of a portion of the dispenser in FIG. 5.

FIG. 8 is a perspective view of a flame mitigating fluid dispenser according to another embodiment where the dispenser is in the form of a fitment for attachment to a container.

FIG. 8A is a top view of the fitment of FIG. 8.

FIG. 8B is a side view of the fitment of FIG. 8.

FIG. 8C is a section view of the fitment of FIG. 8 taken along lines 80-8C in FIG. 8A.

FIG. 8D is an enlarged view of a portion of the fitment from FIG. 8A.

FIG. 9 is a top view of the fitment of FIG. 8 shown inserted into the neck of a container.

FIG. 9A is a section view of the fitment of FIG. 9 taken along lines 9A-9A in FIG. 9.

FIG. 10 is a perspective view of a flame mitigating fluid dispenser according to another embodiment where the dispenser is in the form of a fitment for attachment to a rimmed container neck.

FIG. 10A is a top view of the fitment of FIG. 10.

FIG. 10B is a side view of the fitment of FIG. 10.

FIG. 10C is a section view of the fitment of FIG. 10 taken along lines 10C-10C in FIG. 10A.

FIG. 10D is a section view of the fitment of FIG. 10 shown attached to the neck of a container.

### BRIEF DESCRIPTION OF THE EMBODIMENTS

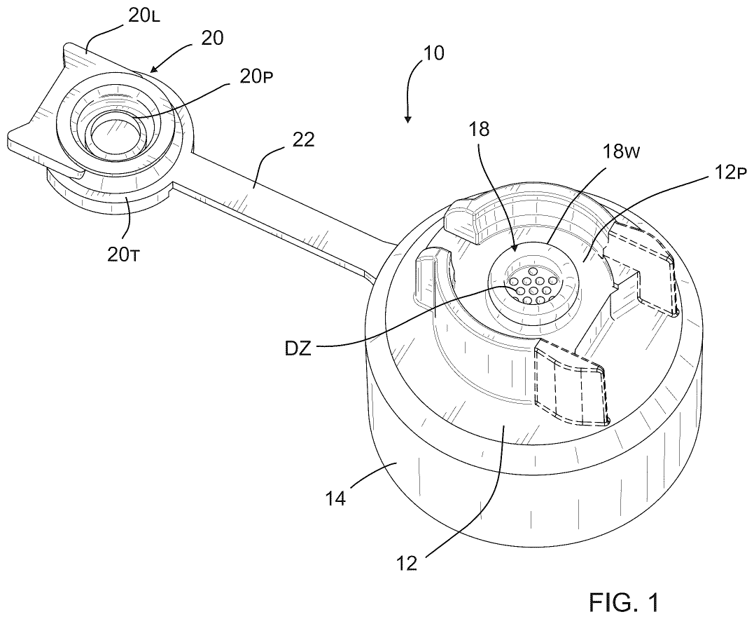

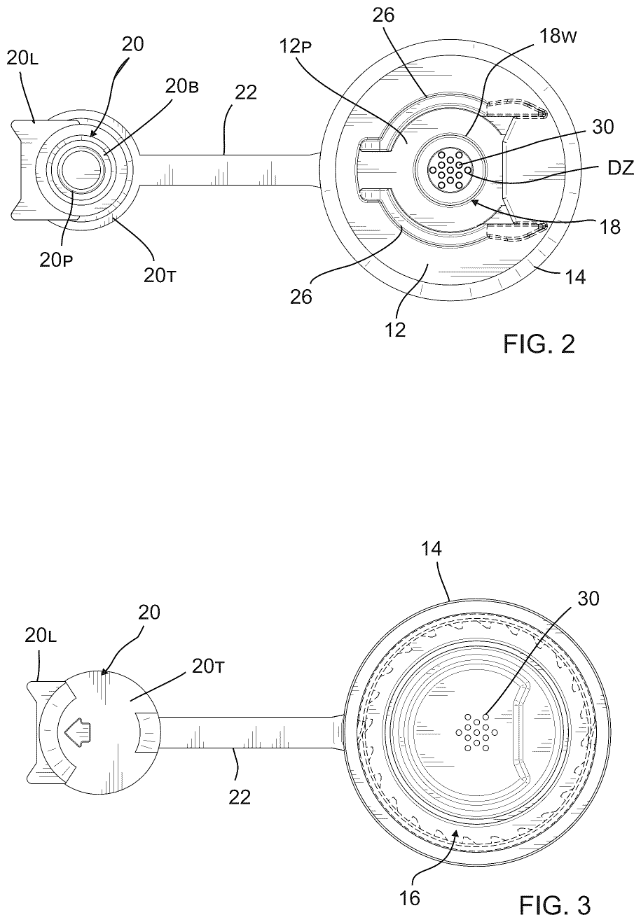

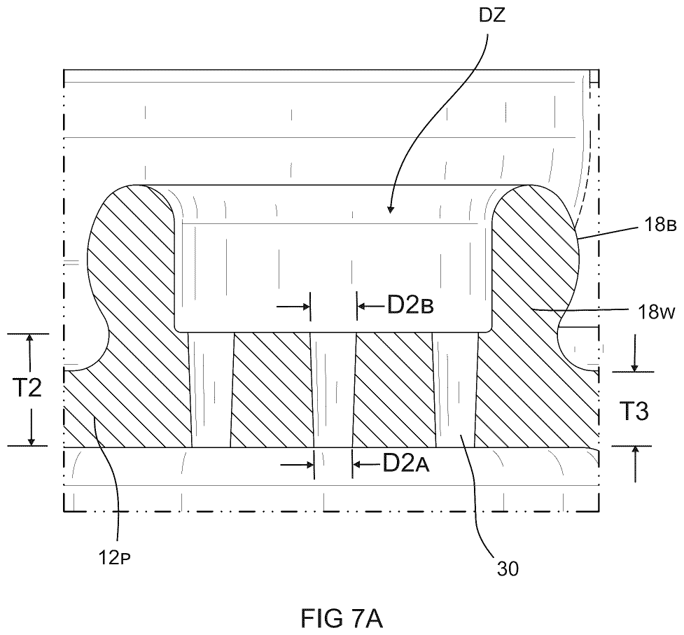

The present invention is directed to a flame mitigating fluid dispenser for controlling the flow of flammable fluid from a container. Referring to FIGS. 1-5 and 7A, an embodiment of the fluid dispenser is shown in the form of a closure 10. The closure 10 includes a top wall 12, a substantially cylindrical annular side wall 14 extending downward from the top wall 12 and an open bottom 16. The closure 10 is preferably made from polyethylene or similar material that does not deteriorate in the presence of the applicable fuel. The particular closure shown is in the form of a child resistant closure, however the present invention is applicable to other closures.

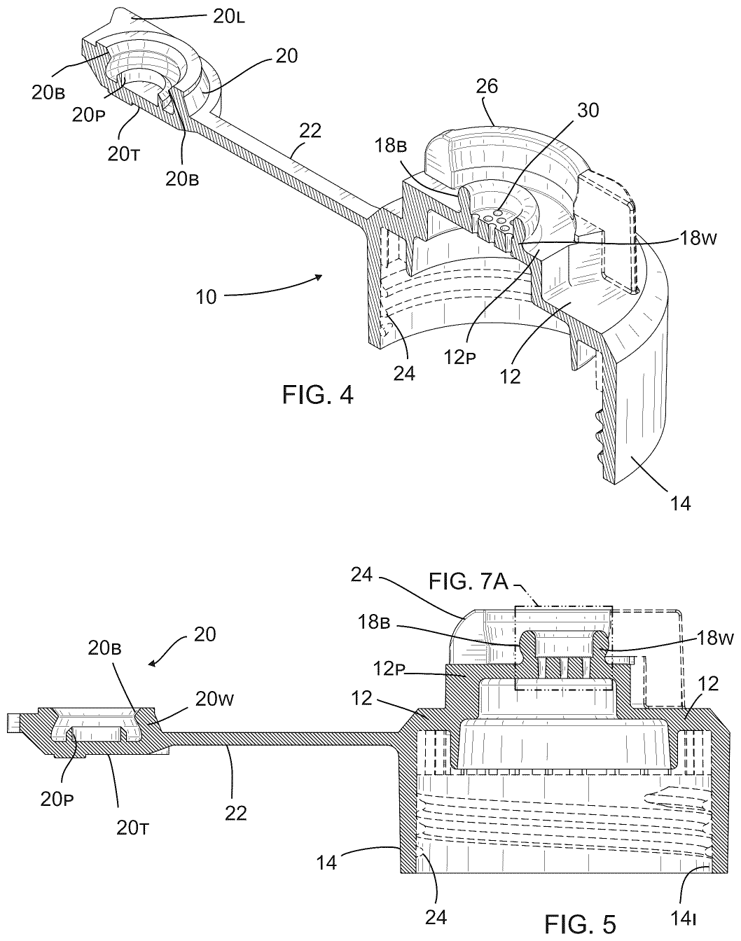

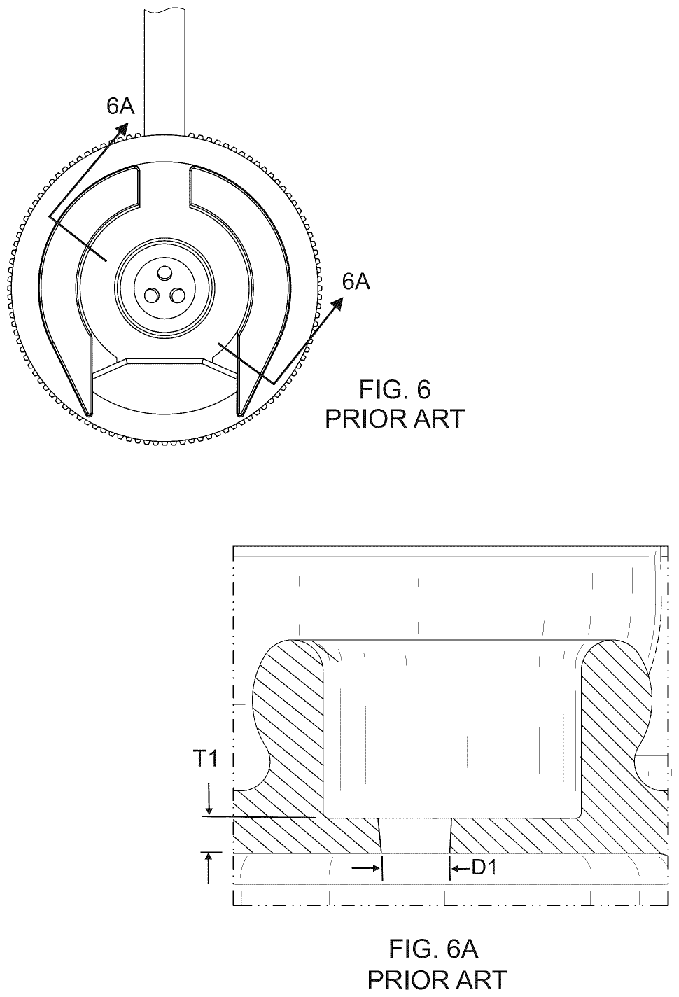

A spout 18 is located generally in the center of the top wall 12 and includes a generally cylindrical wall 18_{W} formed integral with and projecting upwards from the top wall 12. In the illustrated embodiment, the spout 18 is located on a raised platform 12_{P} on the top wall 12. As shown in FIGS. 4 and 5, the spout preferably includes a bulbous portion 18B on an upper outer surface of the wall 18_{W}.

A lid 20 (FIGS. 4 and 5) is provided and configured to removably attach to the spout 18. More particularly the lid 20 includes a top surface 20_{T}, and a cylindrical annular locking wall 20_{W} that projects downward from the bottom of the top surface (shown inverted in FIGS. 4 and 5). The locking wall 20_{W} includes a bulbous portion 20B on a lower inner portion of the locking wall 20_{W}. As should be apparent, the bulbous portion of the locking wall 20_{W} rests below the bulbous portion 18B on the spout wall 18_{W} thus securing the lid 20 to the spout 18 when the dispenser 10 is in its locked position. A plug seal 20_{P} is preferably formed integral with and extends downward from the bottom of the top surface 20_{T} and is designed to engage against and form a seal with the inner surface of the spout wall 18_{W}. A lip 20L is preferably provided on one edge of the lid 20 to facilitate disengagement of the lid 20 from the spout 18 by a user lifting the lip 20L. The lid 20 is preferably attached to the sidewall 14 of the dispenser 10 through an elongated flexible arm 22.

The inner wall 14| of the closure 10 may include attachment components designed to engage with the neck on a container. In the illustrated embodiment, the attachment components are threads 24 that engage with mating threads on the container neck. However, it is also contemplated that the closure may be configured to snap onto a neck on a container.

At least one, and more preferably two safety walls 26 are preferably formed on and extend upwards from the top wall 12 of the closure 10. The safety walls 26 are spaced apart from one another and positioned on opposite sides of the spout 18. The safety walls 26 are located so as to capture the lid 20 therebetween. The safety walls 26 restrict the motion of the lid 20 so that it can only be removed from the spout by pivoting the lid in one direction.

Similar to the prior art, the present invention includes a plurality of holes or apertures 30 are formed in the top wall 12 of the closure for dispensing. However, as discussed above, the closure must be designed to inhibit fire intrusion into a container to which the closure is attached. In order to do so, there are two tests that the closure must pass. The first test is an endurance test, in which the closure is subjected to an external and stationary 2.5-inch flame at the mouth of the closure for 30 seconds. The second test is a flashback test, in which the container is subjected to an external flash fire near the container mouth. The container passes each test if the interior contents of the container do not catch fire or otherwise ignite. The prior art designs were not able to pass these tests.

The applicant has determined that reducing the diameters of holes and increasing the number of holes provides sufficient fluid flow while inhibiting the ability of a flame in close proximity to the closure to pass through the holes. More specifically, in the illustrated embodiment there are thirteen holes 30 arranged in a pattern in a dispensing zone DZ of the top wall 12 and spaced substantially equidistant from one another within the confines of the spout 18. Each hole preferably has a diameter D2_{A} of approximately 0.030 inches on the lower surface of the top wall, i.e., the surface of the top wall closest to the flammable fluid when the dispenser is installed on a container. The holes preferably have a slight draft from an upper surface of the top wall to the lower surface to permit ease of tool removal during manufacturing resulting in an exit diameter D2_{B} on the upper surface of the top wall of approximately 0.036 inches. Thus, the total dispensing area for fluid spread across the top is approximately 0.01344 in². While this actually results in a larger area of openings in the top wall, it has been determined that the size of the holes is more determinative of flame passage. Thus, the use of more, but smaller holes, mitigates against flame intrusion into the container, while facilitating ease of dispensing of fuel from the container. To maintain structural stability for the top wall, the holes are preferably spaced apart (i.e., material between holes) approximately 0.030 inches from one another (on the top surface of the top wall).

The thickness T2 of the top wall 12 at the location where the holes 30 are located (i.e., in the dispensing zone) is also thicker than the thickness T3 of the remainder of the top wall 12 spaced away from the dispensing zone. Preferably the thickness T2 is at least 0.090 inches. This is thicker than the prior art top wall. The additional thickness creates a total volume of the openings of 0.00101 in³. The inventor has determined that the thicker top wall inhibits passage of heat and flames such that the closure can survive exposure to an open flame for more than thirty seconds.

As noted above, the closure 10 is made from a single molded piece of polyethylene. Use of plastic is preferred over incorporating any metal component, especially a metallic dispersing screen for two reasons. First, manufacturing a closure from multiple components and, in particular, from different materials complicates the manufacturing process and increases costs. More importantly, the utilization of a metallic screen to disperse fluids can create a fire hazard for flammable fluids since such a component would be ungrounded and vulnerable to conducting sparks of static electricity/static charge to the fluid as it discharges. A plastic closure alleviates this issue.

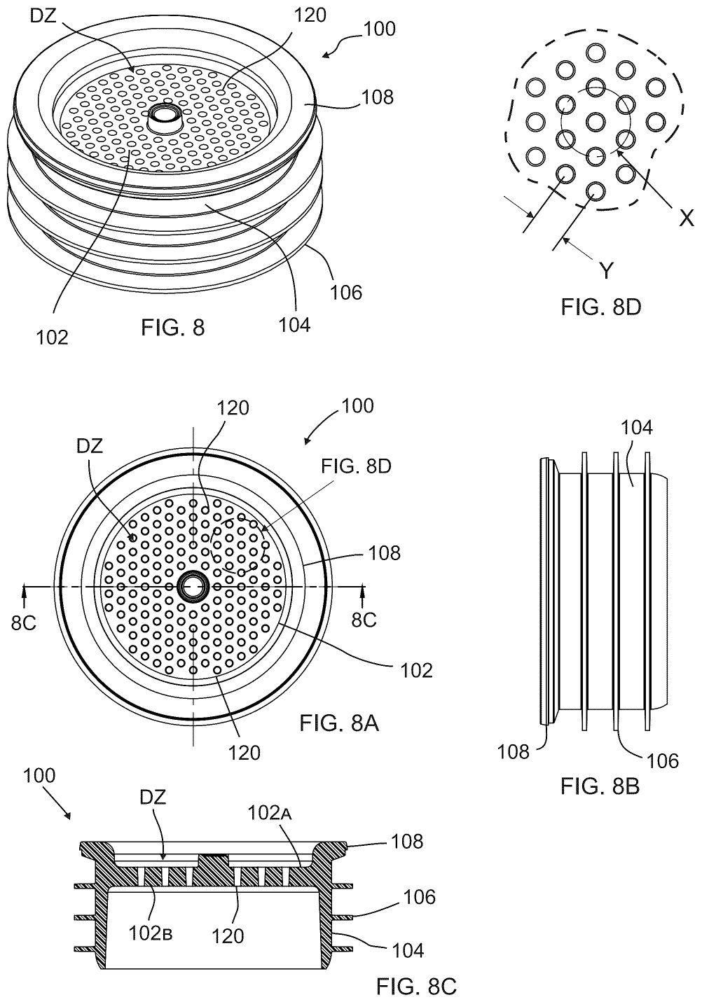

Referring now to FIGS. 8, 8A, 8B, and 8C an alternate embodiment of a flame mitigating fluid dispenser 100 is shown. In this embodiment, the flame mitigating dispenser 100 is fabricated as a fitment or plug that is configured to be placed in/inserted into the neck 150 of the fluid container 152. The flame mitigating fitment 100 includes a top wall 102 and a downward extending sidewall 104. The sidewall 104 is preferably cylindrical with a main outer diameter that is sized to be small than the inner diameter of the neck 150 of the container 152. At least one and more preferably a plurality of protrusions or rings 106 extend outward from the sidewall 104 and have an outer periphery with a diameter that is larger than the inner diameter of the neck 150. The rings 106 are configured to be flexible so as to deform to the contour of the inner diameter of the neck, thereby providing a seal as will be discussed below.

An upper rim 108 extend outward from the top wall 102 with an outer periphery with a diameter that is slightly larger than the inner diameter of the neck 150.

The top wall 102 includes a plurality of holes 120 arranged in a pattern around the dispensing zone DZ of the top wall 102. In the illustrated embodiment, each hole 120 has a diameter of 0.030 inches on the lower surface 102_{B} of the top wall 102. The hole 120 tapers outwards approximately two degrees from the lower surface 102_{B} to the upper surface 102_{A} such that the hole 120 is slightly larger on the upper surface 102_{A} of the top wall 102, preferably about 0.036 inches. The top wall 102 thickness is approximately 0.090 inches. For an insert sized to fit into a 38 mm container neck 152, there are preferably about 144 holes in the dispensing zone DZ. Referring to FIG. 8D, the holes 120 preferably have a spacing Y of approximately 0.066 inches (center to center) between adjacent holes. The assures that the spacing between holes is generally no less than 0.030 inches. The holes 120 are preferably arranged in a pattern such that six holes have their centers located on a diameter X of approximately 0.132 inches with an additional hole centered inside as shown in FIG. 8D. This arrangement has been determined to provide sufficient flow dispersion while mitigating flame propagation into the container. By maintaining a minimum hole diameter of about 0.030 inches, a distance between holes of about 0.030 inches and a minimum top wall thickness of approximately 0.090″ provides sufficient flame intrusion prevention regardless of the diameter of the closure.

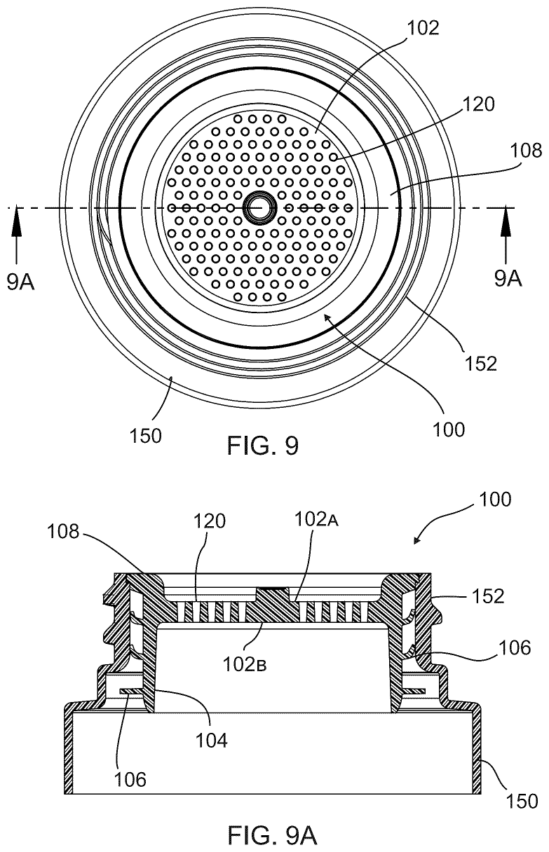

Referring to FIG. 9, a top view of the fitment 100 shown mounted to container 150. FIG. 9A is a cross-sectional view of the fitment 100 is shown positioned within the neck 152 of the container 152. As shown the rings 106 deform slightly as the fitment 100 in press fit into the neck 152 of the container 150. This allows the rings 106 to function as seals and thereby prevent fluid from exiting out of the container between the neck 152 and the fitment 100, while also preventing the fitment 100 from being easily removed from the container 150. A conventional cover would be threaded onto the neck of the container to close the container top.

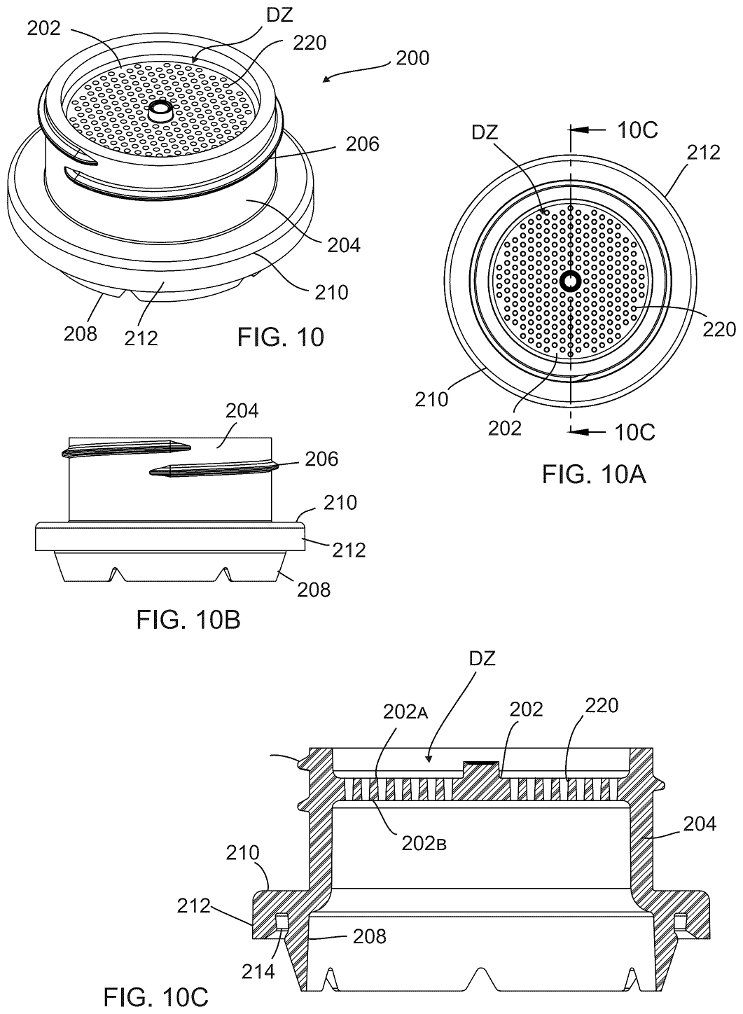

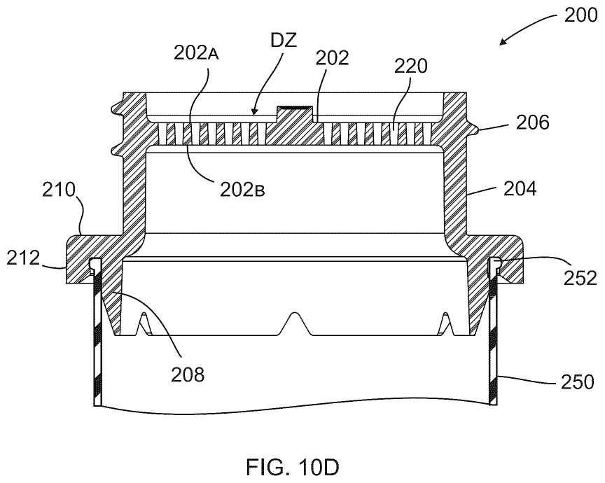

Referring to FIGS. 10, 10A, 10B and 10C, another embodiment of a flame mitigating dispenser 200 is shown. In this embodiment, the dispenser is in the form of a fitment 200 configured to attach to a container 250 that includes a neck 252 with a rim or flange 254. More specifically, for containers that are made from a metallic material, it is common for the neck of the container to include a rolled or formed rim or flange 254. In certain cases it is also desirable to attach a threaded closure such containers. As will be discussed below, in order to attach a plastic flame mitigating fitment 200 to the container so as to prevent or inhibit easy removal, the fitment 200 must be configured to securely mount to the rim 254 of the neck 252 in a manner that secures the fitment 200 in place.

As shown in the figures, in this embodiment the flame mitigating fitment 200 includes a top wall 202 and a downward extending sidewall 204. The sidewall 104 is preferably cylindrical with an attachment such as a thread 206 formed around its periphery that is configured to engage with a mating attachment or thread on a conventional cap. The bottom of the sidewall 204 includes an inner plug seal 208 that has an outer diameter that is sized to engage with and seal against the inner diameter of the neck 252 of the container 250.

A fitment flange 210 extends radially outward from the bottom of the sidewall 204 and includes a downward extending outer ring 212 that is spaced apart from the inner plug seal 208 so as to define an annular gap 214. The width of the gap 214 is sized to receive the rim 254 of the container neck 252.

The top wall 202 includes dispensing zone DZ with a plurality of holes 220 arranged in a pattern around the surface of the top wall. As with the prior embodiment, each hole 220 has a diameter of 0.030 inches on the lower (inner) surface 202_{B} of the top wall 202 and tapers outward approximately two degrees from the lower surface 202_{B} to the upper surface 202_{A} of the top wall 202. The top wall 202 thickness is approximately 0.090 inches. The holes 220 preferably have a spacing Y of approximately 0.066 inches (center to center) between adjacent holes (as shown in FIG. 8D). The holes 220 are preferably arranged in a pattern such that six holes have their centers located on a diameter X of approximately 0.132 inches with an additional hole centered inside as shown in FIG. 8D.

Referring to FIG. 10D, a cross-section of the fitment 200 is shown attached to a container 250. As discussed above, the container includes a neck 252 with a rim or flange 254. The fitment 200 is slid onto the neck 254 of the container 250 such that the inner plug seal 208 slides along the surface of the inside diameter of the neck 254. The downward pressure causes the outer ring 212 to flex around the rim 254 so that the rim is captured in the gap 214. The outer ring 212 includes a slight inward protrusion 212_{P} that is configured to engage under the rim 254 thereby securing the fitment 200 to the neck 254.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

Terms such as “about” or “approximately”, unless otherwise defined or restricted in the specification, should be understood to define a variance of plus or minus 5%-10% to the numerical term referred to.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. The various embodiments and elements can be interchanged or combined in any suitable manner as necessary.

The use of directions, such as forward, rearward, top and bottom, upper and lower are with reference to the embodiments shown in the drawings and, thus, should not be taken as restrictive. Reversing or flipping the embodiments in the drawings would, of course, result in consistent reversal or flipping of the terminology.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalent.

1. A flame mitigating fluid dispenser for controlling flow of flammable fluid from a container while mitigating flame infiltration, the dispenser configured to attach to the container and comprising
a top wall with an upper surface, a lower surface and defining a thickness between the upper and lower surfaces, the top wall having a dispensing zone wherein the thickness of the top wall is at least approximately 0.090 inches;
a plurality of holes formed in the top wall in the dispensing zone, the holes extending through the thickness, each hole having a diameter of approximately 0.030 inches or less at the point where the hole meets the lower surface, each hole being spaced apart from an adjacent hole by at least approximately 0.030 inches on the upper surface; and
a sidewall formed on and depending downward from an outer periphery of the top wall.

2. The dispenser of claim 1, wherein the thickness of the top wall in the dispensing zone is thicker than the thickness of the top wall outside of the dispensing zone.

3. The dispenser of claim 1, wherein the dispenser is part of a closure that attaches to the container, the sidewall is cylindrical and has an open bottom; wherein the closure includes a spout located on the top wall and including a spout wall formed integral with and projecting upwards from the top wall, the spout wall surrounding the dispensing zone of the top wall; and a lid attached to the closure by means of an elongated flexible arm and wherein the lid is configured to removably attach to the spout for covering the dispensing zone.

4. The dispenser of claim 3, wherein the lid includes a top surface, and a locking wall that projects downward from the bottom of the top surface, the locking wall including a bulbous portion on a lower inner portion of the locking wall configured to engage with a corresponding bulbous portion on the spout wall for securing the lid to the spout when the dispenser is in a locked position.

5. The dispenser of claim 3, wherein there is at least one safety wall formed on and extending upwards from the top wall of the closure, the at least one safety wall being spaced apart from the spout, the safety wall configured to engage with the lid so as to restrict the motion of the lid.

6. The dispenser of claim 3, wherein the dispensing zone is located within the spout; and wherein there are at least thirteen holes arranged in a pattern in the dispensing zone of the top wall and spaced substantially equidistant from one another.

7. The dispenser of claim 3, wherein the diameter of each hole on the upper surface has a diameter of approximately 0.036 inches and wherein the holes account for a total area in the dispensing zone on the upper surface of approximately 0.01344 in².

8. The dispenser of claim 1, wherein the dispenser is a fitment configured to fit within a neck of the container, the sidewall of the fitment having at least one ring extending radially outward from the sidewall and having a radially outer end having a diameter that is larger than an inner diameter of the neck of the container; the ring having a thickness and material properties so as to be deformable to the contour of the inner diameter of the neck for providing a seal; and an upper rim extending radially outward from the top wall and having an outer periphery with a diameter that is slightly larger than the inner diameter of the neck.

9. The dispenser of claim 8, wherein there are about 144 holes and wherein adjacent holes preferably have a spacing of approximately 0.066 inches center to center.

10. The dispenser of claim 9, wherein the holes are arranged in a pattern such that six of the holes are arranged in a circle with their centers located on a diameter of approximately 0.132 inches with an additional hole centered inside the six holes.

11. The dispenser of claim 1, wherein the dispenser is a fitment configured to fit within a neck of the container that includes an outward projecting rim, the sidewall of the fitment has an outer attachment formed around its periphery;
the dispenser further comprises a cap with an internal attachment configured to mate with the outer attachment on the sidewall for removably securing the cap to the sidewall and covering the top wall;
wherein the bottom of the sidewall includes an inner plug seal that has an outer diameter that is sized to engage with and seal against the inner diameter of the neck of the container; and
a fitment flange extends radially outward from the bottom of the sidewall and includes a downward extending outer ring that is spaced apart from the inner plug seal so as to define an annual gap, the width of the gap is sized to receive the rim of the neck of the container.

12. The dispenser of claim 11, wherein there are about 144 holes and wherein adjacent holes preferably have a spacing of approximately 0.066 inches center to center.

13. The dispenser of claim 11, wherein the holes are arranged in a pattern such that six of the holes are arranged in a circle with their centers located on a diameter of approximately 0.132 inches with an additional hole centered inside the six holes.
